(19) United States
(12) Patent Application Publication
(10) Pub. No.: US 2020/0164321 A1
(43) Pub. Date: May 28, 2020

(54) BUBBLE GENERATING DEVICE FOR VORTEX PUMP

(71) Applicant: Guangzhou Maiguang Electronic Technology Co., Ltd, Guangzhou (CN)

(72) Inventor: Weixin Liang, Guangzhou (CN)

(21) Appl. No.: 16/583,370

(22) Filed: Sep. 26, 2019

Related U.S. Application Data
(63) Continuation of application No. PCT/CN2019/074366, filed on Feb. 1, 2019.

(30) Foreign Application Priority Data
Nov. 22, 2018 (CN) 201811400539.0
Nov. 22, 2018 (CN) 201821940057.X

(51) Int. Cl. B01F 5/16; B01F 3/04; C02F 1/24

(52) U.S. Cl. CPC B01F 5/165; C02F 2103/08; C02F 1/24; B01F 3/04099

(57) ABSTRACT

The present invention discloses a bubble generating device for a vortex pump, includes an impeller and a stirring wheel provided coaxially with the impeller, wherein a stirring chamber is formed between the impeller and the stirring wheel, a water inlet hole is provided in the middle of the stirring wheel, and the water inlet hole is communicated with the water inlet of the vortex pump and is communicated with the stirring chamber. A stirring convex portion in the stirring chamber is selectively provided on the impeller or the stirring wheel. Correspondingly, a stirring concave portion in the stirring chamber is selectively provided on the impeller or the stirring wheel, and the stirring convex portion is inserted into the stirring concave portion. The present invention can generate smaller and more uniform bubbles and increase the surface area of the bubbles.

### CROSS REFERENCE TO RELATED APPLICATIONS

The present application is a Continuation Application of PCT Application No. PCT/CN2019/074366 filed on Feb. 1, 2019, which claims the benefit of Chinese Patent Application Nos. 201811400539.0 and 201821940057.X filed on Nov. 22, 2018. All the above are hereby incorporated by reference.

### TECHNICAL FIELD

The present invention relates to the field of vortex pump technology of a protein separator, and in particular to a bubble generating device for a vortex pump.

### BACKGROUND

The protein separator is a device that can purify seawater. The specific work flow is as follows: the high-speed rotation of the impeller in the vortex pump in the protein separator simultaneously sucks the seawater and the air into the vortex pump, the protrusion provided on the impeller cuts the water-gas mixture sucked into the vortex pump to generate a large amount of bubbles in the water, the surface of the bubble is used to adsorb various granular dirt and soluble organic matter mixed in the water, the bubbles adsorbed to the dirt are finally concentrated on the water surface to form foam, and the purification of the seawater can be achieved by removing the foam. However, when the existing vortex pump impeller cuts and stirs the water-gas mixture, the volume of the generated bubbles is different, and the bubble volume is relatively large, so that the protein separator has low dirt adsorption capacity and low purification ability.

It can be seen that the prior art still has certain defects.

### SUMMARY

In view of this, in order to solve the problems in the prior art, the present invention proposes a bubble generating device for a vortex pump.

The present invention solves the above problems by the following technical means:

A bubble generating device for a vortex pump, comprising: an impeller and a stirring wheel provided coaxially with the impeller, wherein a stirring chamber is formed between the impeller and the stirring wheel, a water inlet hole is provided in the middle of the stirring wheel, the water inlet hole is communicated with the water inlet of the vortex pump and is communicated with the stirring chamber, a stirring convex portion in the stirring chamber is selectively provided on the impeller or the stirring wheel, correspondingly, a stirring concave portion in the stirring chamber is selectively provided on the impeller or the stirring wheel, and the stirring convex portion is inserted into the stirring concave portion.

Further, the stirring convex portion is provided on the impeller, and correspondingly, the stirring concave portion is provided on the stirring wheel.

Further, the stirring convex portion is provided on the stirring wheel, and correspondingly, the stirring concave portion is provided on the impeller.

Further, the stirring convex portion is a plurality of protruding posts uniformly arranged around the axis of the impeller, the axes of the plurality of protruding posts are all arranged on a virtual circle, and the center of the virtual circle coincides with the axis of the impeller.

Further, the protruding post is a tapered post.

Further, the stirring concave portion is a gap formed between a plurality of first protruding rods and a plurality of second protruding rods uniformly arranged around the axis of the impeller, the axes of the plurality of first protruding rods are all arranged on a virtual circle, the axes of the plurality of second protruding rods are arranged on another virtual circle, the centers of the two virtual circles coincide with the axis of the impeller, and the stirring convex portion is inserted into the gap between the first protruding rods and the second protruding rods.

Further, the first protruding rods and the second protruding rods are tapered posts.

Further, the impeller is provided with two stirring concave portions, correspondingly, the stirring wheel is provided with two stirring convex portions, and the two stirring convex portions are in one-to-one correspondence with and are inserted into the two stirring concave portions.

Further, the impeller is provided with two stirring convex portions, correspondingly, the stirring wheel is provided with two stirring concave portions, and the two stirring convex portions are in one-to-one correspondence with and are inserted into the two stirring concave portions.

Further, an end surface of the stirring wheel is provided with a mounting sleeve away from the stirring chamber, and the mounting sleeve is closely connected with the mounting hole provided by the vortex pump.

Compared with the prior art, the beneficial effects of the present invention are as follows:

The impeller rotates about its own axis with respect to the stirring wheel, and the stirring concave portion and the stirring convex portion in the stirring chamber rotate with each other to cut the seawater entering the stirring chamber, which can generate smaller and more uniform bubbles and increase the surface area of the bubbles, thereby improving the dirt adsorption capacity of a protein separator.

### BRIEF DESCRIPTION OF THE DRAWINGS

In order to more clearly illustrate the technical solutions in the present embodiments of the present invention, the drawings used in the description of the embodiments will be briefly described below. It is obvious that the drawings in the following description are merely some embodiments of the present invention. Other drawings may also be obtained according to these drawings without creative efforts for those skilled in the art.

FIG. 1 is a schematic view illustrating the structure of an impeller according to the present invention;

FIG. 2 is a schematic view illustrating the structure of a stirring wheel according to the present invention;

FIG. 3 is a cross-section perspective schematic view of the present invention.

### DESCRIPTION OF THE REFERENCE NUMBERS

1. Impeller; 2. Stirring wheel; 3. Stirring chamber; 4. Water inlet hole; 5. Stirring convex portion; 6. Stirring concave portion; 7. Protruding post; 8. Mounting sleeve; 9. First protruding rod; 10. Second protruding rod

### DESCRIPTION OF THE EMBODIMENTS

The technical solution of the present invention will be described in detail below with reference to the accompanying drawings and specific embodiments so that the above objects, features, and advantages of the present invention are more apparent. It should be noted that the described embodiments are merely some embodiments of the present invention, rather than all of the embodiments. Based on the embodiments of the present invention, all other embodiments obtained by those skilled in the art without creative efforts are within the scope of protection of the present invention.

It is to be understood that the orientation or positional relationship of the terms such as “top”, “bottom” and the like is based on the orientation or positional relationship shown in the drawings, and is merely for the convenience of the description of the present invention and the simplified description, rather than indicating or implying that the device or component indicated must have a particular orientation or be configured and operated in a particular orientation, and thus is not to be construed as limiting the present invention.

The terms “first”, “second”, and “third” are used for descriptive purposes only and are not to be construed as indicating or implying a relative importance or implicitly indicating the number of technical features indicated. Thus, features defining “first”, “second”, and “third” may comprise one or more of the features, either explicitly or implicitly. In the description of the present invention, “a group” means two or more unless otherwise stated.

### Embodiment

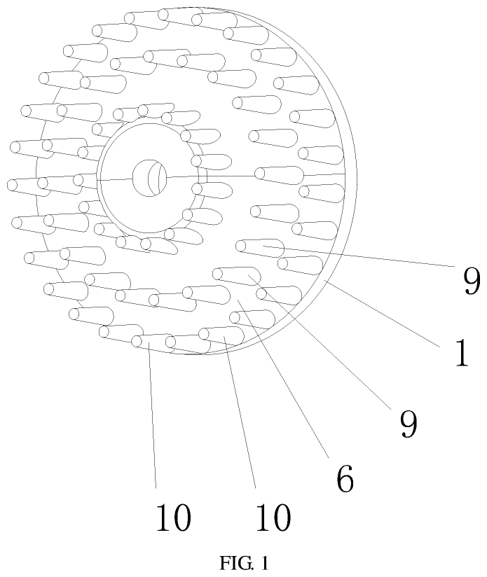

As shown in FIGS. 1 to 3, the present invention provides a bubble generating device for a vortex pump, specifically comprising an impeller 1 and a stirring wheel 2 provided coaxially with the impeller 1, wherein a stirring chamber 3 is formed between the impeller 1 and the stirring wheel 2, a water inlet hole 4 is provided in the middle of the stirring wheel 2, the water inlet hole 4 is communicated with the water inlet of the vortex pump and is communicated with the stirring chamber 3, a stirring convex portion 5 in the stirring chamber 3 is selectively provided on the impeller 1 or the stirring wheel 2, correspondingly, a stirring concave portion 6 in the stirring chamber is selectively provided on the impeller 1 or the stirring wheel 2, and the stirring convex portion 5 is inserted into the stirring concave portion 6. In the present embodiment, the stirring convex portion 5 is provided on the stirring wheel 2, and correspondingly, the stirring concave portion 6 is provided on the impeller 1. In other embodiments, the stirring convex portion 5 may be provided on the impeller 1, and correspondingly, the stirring concave portion 6 may be provided on the stirring wheel 2 according to actual needs.

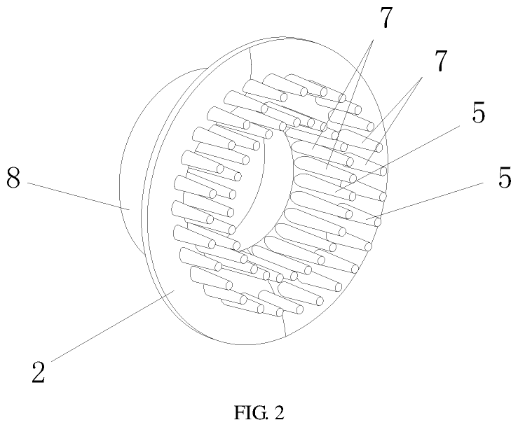

As shown in FIGS. 1 and 2, the impeller 1 and the stirring wheel 2 are both disk-shaped, the center of the disk is mounted to the stirring shaft of the vortex pump, the stirring convex portion 5 or the stirring concave portion 6 is provided on the disk surface of the impeller 1 or the stirring wheel 2 opposite to each other, and the position of the stirring convex portion 5 corresponds to the position of the stirring concave portion 6 so that the stirring convex portion 5 is inserted into the stirring concave portion 6. In the present embodiment, the stirring convex portion 5 is a plurality of protruding posts 7 protruding outward from the disk surface of the impeller 1 or the stirring wheel 2, the protruding posts 7 are provided around the disk, the axes of the plurality of protruding posts 7 are arranged on a virtual circle, and the center of the virtual circle is located on the central axis of the impeller 1 or the stirring wheel 2. That is to say, a plurality of protruding posts 7 are arranged in a circle coaxial with the impeller 1 or the stirring wheel 2. The plurality of protruding posts 7 cut the seawater entering the stirring chamber 3, which can generate smaller and more uniform bubbles. Preferably, the protruding posts 7 are uniformly provided on the circumference of the impeller 1 or the stirring wheel 2.

In another embodiment, the stirring convex portion 5 and the stirring concave portion 6 are simultaneously provided on the impeller 1 and the stirring wheel 2, and the stirring convex portion 5 on the impeller 1 is displaced from the stirring convex portion 5 on the stirring wheel 2. The stirring convex portion 5 is provided on the disk surface of the impeller 1 and the stirring wheel 2 facing each other, and the stirring concave portion 6 is a region beside the stirring convex portion 5. In the present embodiment, the stirring convex portion 5 is a plurality of protruding posts 7 protruding outward from the disk surface of the impeller 1 or the stirring wheel 2, the plurality of protruding posts 7 are arranged in a circle coaxial with the impeller 1 or the stirring wheel 2, and the diameter of a circle formed by the protruding post of the stirring convex portion 5 on the impeller 1 is different from that of the stirring convex portion 5 on the stirring wheel 2, so that the stirring convex portion 5 on the impeller 1 is displaced from the stirring convex portion 5 on the stirring wheel 2 in the radial direction. Therefore, when the impeller 1 rotates with respect to the stirring wheel 2, the stirring convex portions 5 do not interfere with each other. When the stirring wheel 2 and the impeller 1 are mounted, the stirring convex portion 5 on the impeller 1 is inserted correspondingly to the stirring concave portion 6 beside the stirring convex portion 5 of the stirring wheel 2, alternatively, the stirring convex portion 5 on the stirring wheel 3 is inserted correspondingly into the stirring concave portion 6 beside the stirring convex portion 5 of the impeller 1.

In one embodiment, the stirring convex portions 5 are arranged in a circle on the impeller 1 or the stirring wheel 2, and the region, which is not protruding, beside the stirring convex portion 5, is the stirring concave portion 6. In another embodiment, the stirring convex portions 5 are arranged on the impeller 1 or the stirring wheel 2 to form a plurality of concentric circles, wherein the gap between the two concentric circles forms the stirring concave portion 6. The stirring convex portion 5 on the impeller 1 is inserted correspondingly into the stirring concave portion 6 of the stirring wheel 2, and the stirring convex portion 5 of the stirring wheel 2 is inserted correspondingly into the stirring concave portion 6 of the impeller 1 so that the stirring convex portions 5 on the impeller 1 and the stirring wheel 2 do not interfere with each other. After the impeller 1 and the stirring wheel 2 are mounted, the stirring convex portions 5 of the impeller 1 and the stirring wheel 2 are arranged to form a plurality of concentric circles, and the centers of the plurality of concentric circles are located on the central axis of the impeller 1 or the stirring wheel 2.

As shown in FIG. 2, specifically, in the present embodiment, the stirring convex portion 5 is provided on the stirring wheel 2, the stirring convex portion 5 is a plurality of protruding posts 7 uniformly arranged around the axis of the impeller 1, the axes of the plurality of protruding posts 7 are all arranged on a virtual circle, and the center of the virtual circle coincides with the axis of the impeller 1. The plurality of protruding posts 7 cut the seawater entering the stirring chamber 3, which can generate smaller and more uniform bubbles. As shown in FIG. 2, in the present embodiment, the protruding post 7 is a tapered post. In other embodiments, the protruding post 7 may be provided in other shapes according to actual needs, such as a cylindrical shape or a square column shape. The protruding post 7 is not limited to a tapered post.

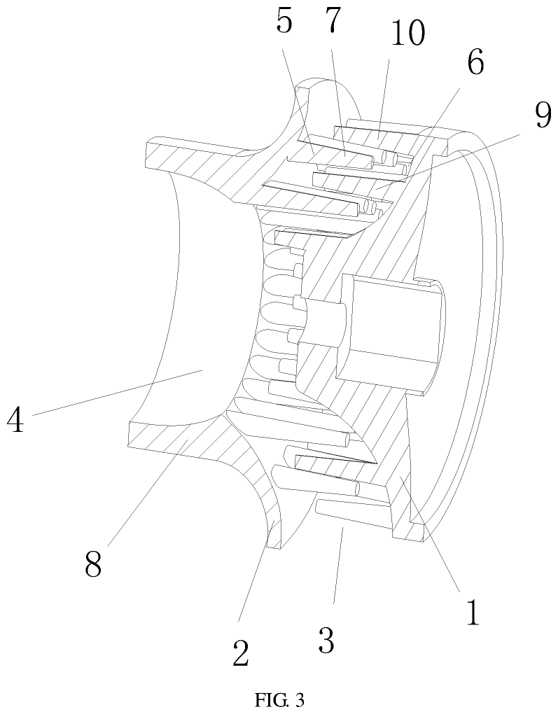

As shown in FIGS. 1 and 3, in the present embodiment, the stirring concave portion 6 is provided on the impeller 1, the stirring concave portion 6 is a gap formed between a plurality of first protruding rods 9 and a plurality of second protruding rods 10 uniformly arranged around the axis of the impeller 1, the axes of the plurality of first protruding rods 9 are all arranged on a virtual circle, the axes of the plurality of second protruding rods 10 are arranged on another virtual circle, the centers of the two virtual circles coincide with the axis of the impeller 1, and the stirring convex portion 5 is inserted into the gap between the first protruding rods 9 and the second protruding rods 10. The plurality of protruding posts 7, the plurality of first protruding rods 9, and the plurality of second protruding rods 10 cut the seawater entering the stirring chamber 3, which can generate smaller and more uniform bubbles. As shown in FIG. 1, in the present embodiment, the first protruding rod 9 and the second protruding rod 10 are tapered posts. In other embodiments, the first protruding rod 9 and the second protruding rod 10 may be provided in other shapes according to actual needs, such as a cylindrical shape or a square column shape. The first protruding rod 9 and the second protruding rod 10 are not limited to a tapered post.

The impeller 1 can be further provided with two stirring concave portions 6, correspondingly, the stirring wheel 2 is provided with two stirring convex portions 5, and the two stirring convex portions 5 are in one-to-one correspondence with and are inserted into the two stirring concave portions 6. The impeller 1 can be further provided with two stirring convex portions 5, correspondingly, the stirring wheel 2 is provided with two stirring concave portions 6, and the two stirring convex portions 5 are in one-to-one correspondence with and are inserted into the two stirring concave portions 6. Of course, the number of the stirring concave portions 6 and the stirring convex portions 5 is not limited to two. Of course, depending on the space size of the impeller 1 and the stirring wheel 2 and actual needs, a plurality of stirring concave portions 6 and stirring convex portions 5 may be arranged.

As shown in FIG. 2, in the present embodiment, an end surface of the stirring wheel 2 is provided with a mounting sleeve 8 away from the stirring chamber 3, and the mounting sleeve 8 is closely connected with the mounting hole provided by the vortex pump. The impeller 1 rotates about its own axis with respect to the stirring wheel 2, and the stirring concave portion 6 and the stirring convex portion 5 in the stirring chamber 3 rotate with each other to cut the seawater entering the stirring chamber 3.

When the seawater is purified, the impeller 1 rotates with respect to the stirring wheel 2, and the stirring concave portion 5 and the stirring convex portion 6 in the stirring chamber 3 rotate with each other to cut the seawater entering the stirring chamber 3, which can generate smaller and more uniform bubbles and increase the surface area of the bubbles, thereby improving the dirt adsorption capacity of a protein separator.

The above embodiments are merely illustrative of several embodiments of the present invention. The description thereof is more specific and detailed, but is not to be construed as limiting the patent scope of the present invention. It should be noted that a number of variations and improvements, all of which are within the scope of protection of the present invention, may be made by those skilled in the art without departing from the spirit and scope of the present invention. Therefore, the scope of protection of the present invention should be determined by the appended claims.

What is claimed is:

1. A bubble generating device for a vortex pump, comprising: an impeller and a stirring wheel provided coaxially with the impeller, wherein a stirring chamber is formed between the impeller and the stirring wheel, a water inlet hole is provided in the middle of the stirring wheel, the water inlet hole is communicated with the water inlet of the vortex pump and is communicated with the stirring chamber, a stirring convex portion in the stirring chamber is selectively provided on the impeller or the stirring wheel, correspondingly, a stirring concave portion in the stirring chamber is selectively provided on the impeller or the stirring wheel, and the stirring convex portion is inserted into the stirring concave portion.

2. The bubble generating device for a vortex pump according to claim 1, wherein the stirring convex portion is provided on the impeller, and correspondingly, the stirring concave portion is provided on the stirring wheel.

3. The bubble generating device for a vortex pump according to claim 1, wherein the stirring convex portion is provided on the stirring wheel, and correspondingly, the stirring concave portion is provided on the impeller.

4. The bubble generating device for a vortex pump according to claim 1, wherein the stirring convex portion is a plurality of protruding posts uniformly arranged around the axis of the impeller, the axes of the plurality of protruding posts are all arranged on a virtual circle, and the center of the virtual circle coincides with the axis of the impeller.

5. The bubble generating device for a vortex pump according to claim 4, wherein the protruding post is a tapered post.

6. The bubble generating device for a vortex pump according to claim 1, wherein the stirring concave portion is a gap formed between a plurality of first protruding rods and a plurality of second protruding rods uniformly arranged around the axis of the impeller, the axes of the plurality of first protruding rods are all arranged on a virtual circle, the axes of the plurality of second protruding rods are arranged on another virtual circle, the centers of the two virtual circles coincide with the axis of the impeller, and the stirring convex portion is inserted into the gap between the first protruding rods and the second protruding rods.

7. The bubble generating device for a vortex pump according to claim 6, wherein the first protruding rods and the second protruding rods are tapered posts.

8. The bubble generating device for a vortex pump according to claim 1, wherein the impeller is provided with two stirring concave portions, correspondingly, the stirring wheel is provided with two stirring convex portions, and the two stirring convex portions are in one-to-one correspondence with and are inserted into the two stirring concave portions.

9. The bubble generating device for a vortex pump according to claim 1, wherein the impeller is provided with two stirring convex portions, correspondingly, the stirring wheel is provided with two stirring concave portions, and the two stirring convex portions are in one-to-one correspondence with and are inserted into the two stirring concave portions.

10. The bubble generating device for a vortex pump according to claim 1, wherein an end surface of the stirring wheel is provided with a mounting sleeve away from the stirring chamber, and the mounting sleeve is closely connected with the mounting hole provided by the vortex pump.
